(19) United States
(12) Patent Application Publication
(10) Pub. No.: US 2025/0385717 A1
(43) Pub. Date: Dec. 18, 2025

(54) POWER REDUCTION FOR MASSIVE MIMO RADIOS

(71) Applicant: Samsung Electronics Co., Ltd., Suwon-si (KR)

(72) Inventors: Mehmet Sahin, Frisco, TX (US); Agrim Gupta, San Diego, CA (US); Shenggang Dong, Dallas, TX (US); Chance Anthony Tarver, Arlington, TX (US); Young Han Nam, Plano, TX (US); Gang Xu, Allen, TX (US)

(21) Appl. No.: 19/173,701

(22) Filed: Apr. 8, 2025

Related U.S. Application Data
(60) Provisional application No. 63/659,673, filed on Jun. 13, 2024.

(51) Int. Cl. H04B 7/0426; H01Q 21/00; H04B 1/40

(52) U.S. Cl. CPC H04B 7/0426; H01Q 21/0006; H04B 1/40

(57) ABSTRACT

Methods and systems for power reduction for massive multiple input multiple output (MIMO) radios. A MIMO communication device includes an array of antenna elements including a plurality of subarrays of the antenna elements, radio frequency (RF) front end circuits coupled to the antenna elements, respectively, and an array of signal conversion circuits coupled to the array of the antenna elements, the signal conversion circuits coupled to the plurality of subarrays, respectively, such that each of the plurality of subarrays is coupled to one of the signal conversion circuits.

### CROSS-REFERENCE TO RELATED AND CLAIM OF PRIORITY

The present application claims priority under 35 U.S.C. § 119(e) to U.S. Provisional Patent Application No. 63/659,673 filed on Jun. 13, 2024, which are hereby incorporated by reference in their entirety.

### TECHNICAL FIELD

The present disclosure relates generally to wireless communication systems. More specifically, the present disclosure relates to a system and method for power reduction for massive multiple input multiple output radios.

### BACKGROUND

The adoption of wireless technologies has led to an ever increasing demand for serving more and more devices with never ending throughput demands. To meet these demands for each device with scarce spectrum, multi-user multiple input multiple output (MIMO, mu-MIMO) technologies have been introduced to enable spectrum efficient and concurrent multi-user communications. Massive MIMO systems having large number of antenna ports are a pivotal part of the FRI sub-6 GHz 5G deployments with a majority of base-stations having digital beamforming (DBF) architecture. The DBF architecture achieves the required high-throughput performance by using all the antennas effectively, however, this requires each antenna to have a set of interfacing hardware, e.g., a radio-frequency (RF) chain. In the RF chain, each of the analog-to-digital converters (ADCs) and digital-to-analog converters (DACs) are costly and consume a substantial amount of power. Thus, having a large number of ADCs or DACs in a MIMO system leads to increased capital expenditure and operating expenditure.

Accordingly, there is a need for systems and methods for improved power reduction for massive multiple input multiple output radios that overcome these challenges.

### SUMMARY

The present disclosure relates generally to wireless communication systems and, more specifically, the present disclosure relates to a system and method for power reduction for massive multiple input multiple output radios.

In one embodiment, a multiple input multiple output (MIMO) communication device is provided. The MIMO communication device includes an array of antenna elements including a plurality of subarrays of the antenna elements, radio frequency (RF) front end circuits coupled to the antenna elements, respectively, and an array of signal conversion circuits coupled to the array of the antenna elements, the signal conversion circuits coupled to the plurality of subarrays, respectively, such that each of the plurality of subarrays is coupled to one of the signal conversion circuits.

In another embodiment, a communication method is provided. The communication method includes processing one or more signals using a multiple input multiple output (MIMO) communication device, the MIMO communication device including: an array of antenna elements including a plurality of subarrays of the antenna elements, radio frequency (RF) front end circuits coupled to the antenna elements, respectively, and an array of signal conversion circuits coupled to the array of the antenna elements, the signal conversion circuits coupled to the plurality of subarrays, respectively, such that each of the plurality of subarrays is coupled to one of the signal conversion circuits.

In yet another embodiment, a non-transitory computer-readable medium is provided. The non-transitory computer-readable medium includes program code, that when executed by at least one processor of an electronic device, causes the electronic device to process one or more signals using an array of antenna elements including a plurality of subarrays of the antenna elements, radio frequency (RF) front end circuits coupled to the antenna elements, respectively, and an array of signal conversion circuits coupled to the array of the antenna elements, the signal conversion circuits coupled to the plurality of subarrays, respectively, such that each of the plurality of subarrays is coupled to one of the signal conversion circuits.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below may be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data may be permanently stored and media where data may be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNB according to embodiments of the present disclosure;

FIG. 3 illustrates an example UE according to embodiments of the present disclosure;

FIG. 4A illustrates a schematic diagram of an example multiple input multiple output (MIMO) communication device according to various embodiments of the present disclosure;

FIG. 4B illustrates a schematic diagram of an example multiple input multiple output (MIMO) communication device according to embodiments of the present disclosure;

FIG. 5 illustrates an example method of digital reconstruction according to embodiments of the present disclosure;

FIG. 6A illustrates a schematic diagram of an example multiple input multiple output (MIMO) communication device undergoing the example digital reconstruction method of FIG. 5 according to embodiments of the present disclosure;

FIG. 6B illustrates a schematic diagram of example signals received by a multiple input multiple output (MIMO) communication device undergoing the example digital reconstruction method of FIG. 5 according to embodiments of the present disclosure;

FIG. 7 illustrates an example method of analog synthesis according to embodiments of the present disclosure;

FIG. 8A illustrates a schematic diagram of an example multiple input multiple output (MIMO) communication device undergoing the example analog synthesis method of FIG. 7 according to embodiments of the present disclosure;

FIG. 8B illustrates a schematic diagram of example signals transmitted by a multiple input multiple output (MIMO) communication device undergoing the example analog synthesis method of FIG. 7 according to embodiments of the present disclosure; and

FIG. 9 illustrates a schematic diagram of an example multiple input multiple output (MIMO) communication device according to embodiments of the present disclosure.

### DETAILED DESCRIPTION

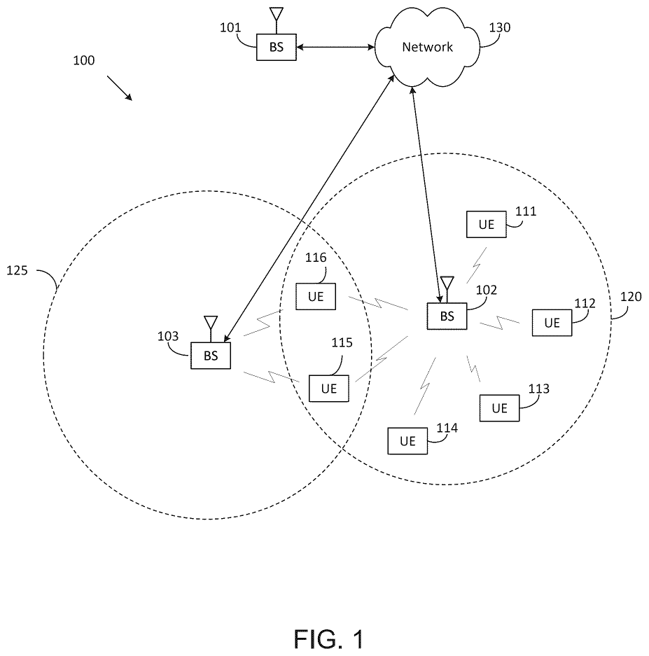

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, massive MIMO systems having large number of antenna ports (e.g., 32-64) has been a pivotal part of the FRI sub-6 GHz 5G deployments with a majority of base-stations having a digital beamforming (DBF) architecture. The DBF architecture achieves the required high throughput performance by using all the antennas effectively, however, this requires each antenna to have a set of interfacing hardware referred to as a radio-frequency (RF) chain that includes analog-to-digital converters (ADCs), digital-to-analog converters (DACs), down- and up-converters, low noise amplifiers (LNAs), power amplifiers (PAs), among other components. In the RF chain, each of the ADCs and the DACs are costly and consume a substantial amount of power. Thus, having a large number of ADCs or DACs in a MIMO system leads to increased capital expenditure and operating expenditure.

Accordingly, the present disclosure provides systems and methods for power reduction for massive multiple input multiple output systems. As described herein, the present disclosure includes a MIMO system having an antenna array having a plurality of subarrays of antenna elements. Each of these subarrays are coupled to an analog multiplexer and an ADC of an array of ADCs for processing received signals or a DAC of an array of DAC for transmitting signals. The systems and methods of the present disclosure allow MIMO systems to interface a large number of antennas at a reduced number of ADC/DACs, leading to a smaller power and economic footprint, while still meeting the same high throughput performance of the traditional DBF architecture.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHZ, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

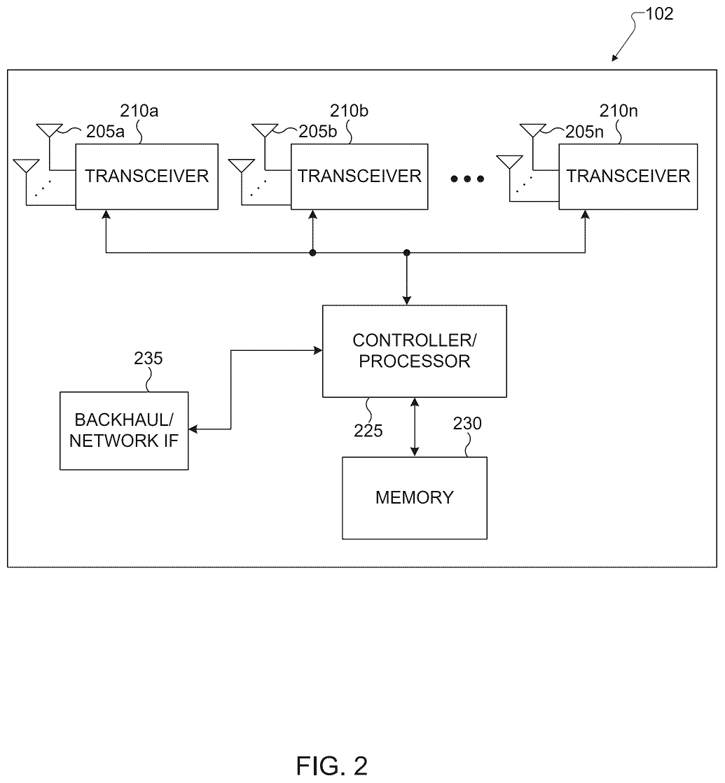

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as an OS. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

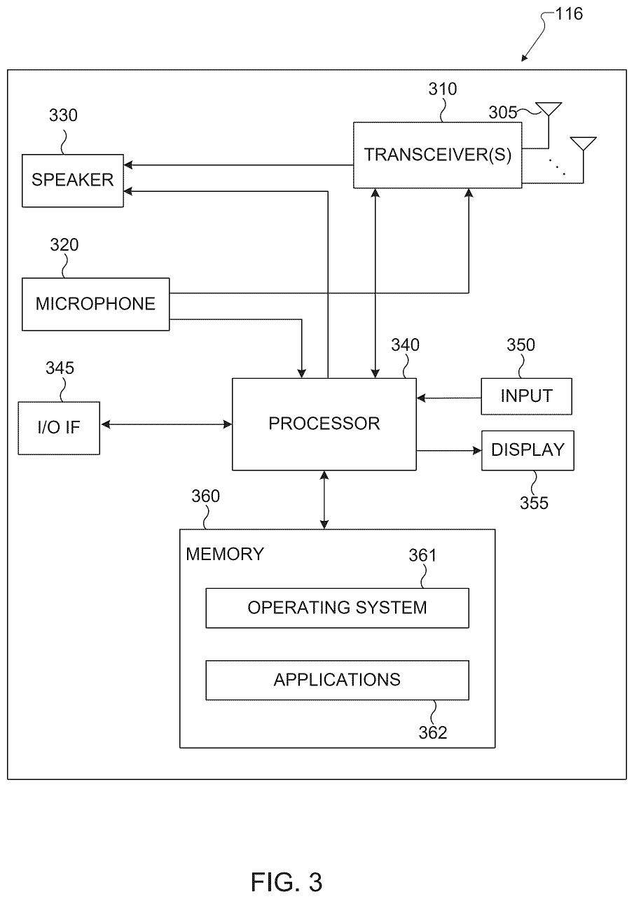

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives, from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

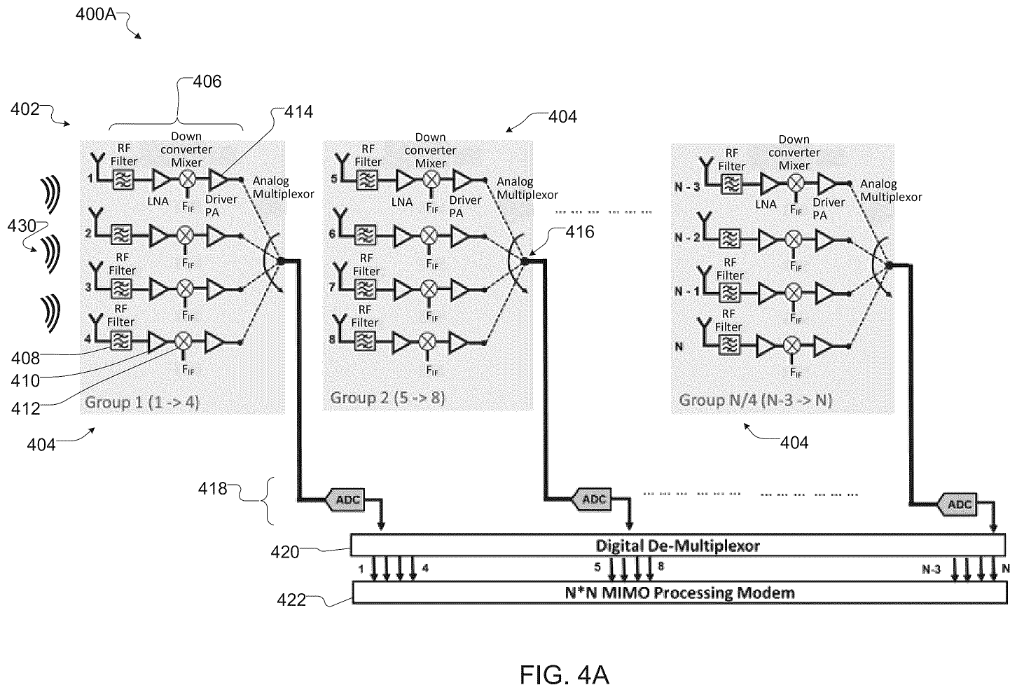

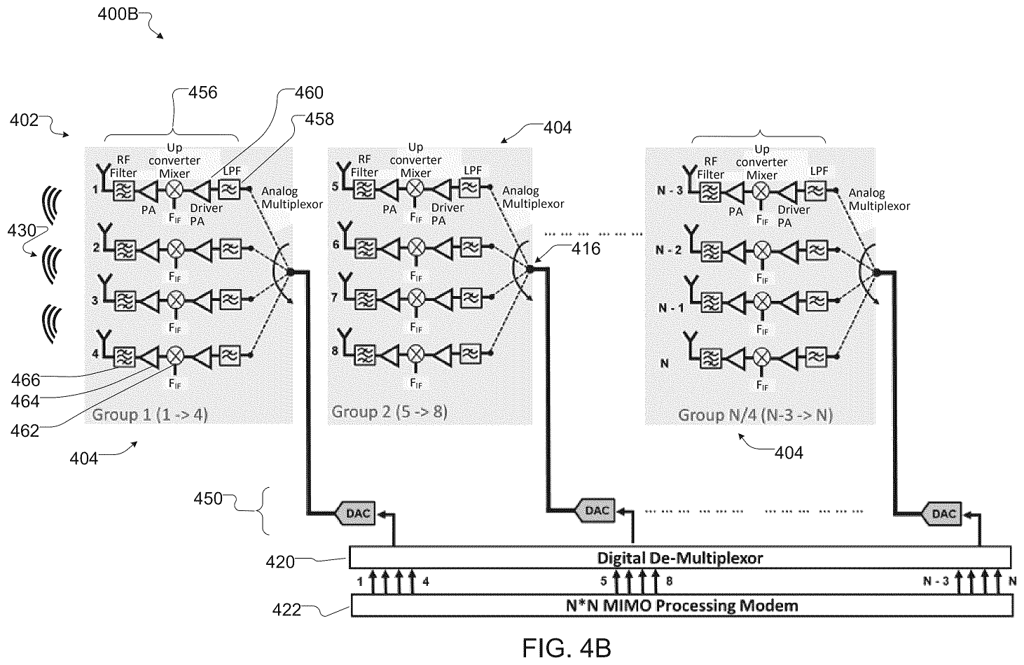

FIG. 4A illustrates a schematic diagram of an example multiple input multiple output (MIMO) communication device 400A according to various embodiments of the present disclosure. The embodiment of the MIMO communication device 400A shown in FIG. 4A is for illustration only. Other embodiments of the MIMO communication device 400A could be used without departing from the scope of this disclosure.

As shown in FIG. 4A, the MIMO communication device 400A is configured to receive RF signals 430 and includes an array of antenna elements 402 separated into a plurality of subarrays of antenna elements 404. The plurality of subarrays of antenna elements 404 contain an equal number of antenna elements such that all of the antenna elements of the array of antenna elements 402 are within one of the plurality of subarrays of antenna elements 404. For example, if the array of antenna elements 402 includes 64 antenna elements, each of the plurality of subarrays of antenna elements 404 may include 4 antenna elements, resulting in 16 subarrays. Each of the antenna elements in each of the plurality of subarrays of antenna elements 404 includes its own RF front end circuit 406. The RF front end circuits 406 may include a RF filter 408, a low noise amplifier (LNA) 410, a down-converter mixer 412 and a power amplifier 414. Although not shown, it is contemplated that the RF front end circuits 406 may include further signal processing components, e.g., additional amplifiers or filters. Each of the RF front end circuits 406 of each of the plurality of subarrays of antenna elements 404 is coupled to one of an array of signal conversion circuits 418 by a multiplexor 416, e.g., an analog multiplexor. In the embodiment as shown, the array of signal conversion circuits 418 includes an analog-to-digital converter (ADC). The array of signal conversion circuits 418 is coupled to a de-multiplexor 420 and subsequently a MIMO processing module 422.

As shown in FIG. 4A, there are a total of N antenna elements in the array of antenna elements 402. Each RF signals 430 received at the antenna elements are filtered using the RF filter 408, amplified using the LNA 410, and then down-converted using the down-converter mixer, e.g., a local oscillator signal, to an intermediate frequency (IF). The IF chosen could also be configured to down-convert directly to baseband (e.g., zero-IF). After down-conversion, the driver power amplifier 414 ensures that the IF signals are boosted to full-scale power. Then, a group of M antenna elements, where M is greater than N, e.g., M=4, share a single ADC of the array of signal conversion circuits 418, via the analog multiplexor 416.

The analog multiplexor 416, as well as the array of signal conversion circuits 418 operate at M times the system sampling bandwidth. By using M times the sampling bandwidth, the analog multiplexor 416, the array of signal conversion circuits 418, and the corresponding de-multiplexor 420 after the array of signal conversion circuits 418 ensure reconstruction of original RF signals 430 at minimal loss. The reconstructed, digitized per-RF signals 430 then undergo N*N MIMO processing in the MIMO processing module 422. Using this analog multiplexing technique, number of array of signal conversion circuits 418 in the architecture may be reduced from N, where each antenna element included an ADC, to NIM, which reduces power consumption of the receiver as the array of signal conversion circuits 418 dominates the receiver power, and reducing cost. Further, it only increases the bandwidth requirements of array of signal conversion circuits 418 by M times, instead of N times.

Although FIG. 4A illustrates one example of a MIMO communication device MIMO communication device 400A, various changes may be made to FIG. 4A. For example, a different quantity of antenna elements, such as 2 or more, such as 3 or more, may be used in each of the plurality of subarrays.

FIG. 4B illustrates a schematic diagram of an example multiple input multiple output (MIMO) communication device MIMO communication device 400B according to embodiments of the present disclosure. The embodiment of the MIMO communication device MIMO communication device 400B shown in FIG. 4B is for illustration only. Other embodiments of the MIMO communication device MIMO communication device 400B could be used without departing from the scope of this disclosure.

As shown in FIG. 4B, the MIMO communication device 400B is configured to transmit the RF signals 430 and includes the array of antenna elements 402 separated into the plurality of subarrays of antenna elements 404. Each of the plurality of subarrays of antenna elements 404 is coupled to one of an array of signal conversion circuits 450. In the embodiment as shown, the de-multiplexor 420 includes a digital-to-analog converter. Each of the antenna elements in each of the plurality of subarrays of antenna elements 404 includes its own RF front end circuits 456. The RF front end circuits 456 may include a low pass filter 458, a first power amplifier 460, an up-converter mixer 462, a second power amplifier 464, and a RF filter 466. Although not shown, it is contemplated that the RF front end circuits 456 may include further signal processing components, e.g., additional amplifiers or filters. Each of the RF front end circuits 456 of each of the plurality of subarrays of antenna elements 404 are coupled to the array of signal conversion circuits 450 by a multiplexor 416.

The configuration of the MIMO communication device 400B is conceptually reciprocal to the MIMO communication device 400A of FIG. 4A. As shown in FIG. 4B, the signal path, e.g., the arrows, is reversed to facilitate a signal transmission from array of signal conversion circuits 450 to the RF front end circuits 456. Here, the input to the array of signal conversion circuits 450 is an MB bandwidth signal created via de-multiplexing M original B bandwidth signals input from the MIMO processing module 422. The array of signal conversion circuits 450 synthesizes the MB input signal, which then passes through the analog multiplexor 416, that loads signals to a particular antenna onto the respective RF front end circuits 456. This multiplexing and de-multiplexing creates higher frequency harmonics that get filtered through using the low pass filters 458 placed before the first power amplifier 460. The number of signal conversion circuits in the array of signal conversion circuits 450 again reduces from N to NIM, and the bandwidth increases by M times.

The MIMO communication devices 400A, 400B are configured to organize the antenna elements in groups, so that multiple antennas can share a single wider-bandwidth array of signal conversion circuits 418, 450. For example, to enable spatial multiplexing with 64 antennas, there may be 16 antenna-groups, with 4 antennas per-group. Each antenna element is connected to its own RF front end circuits 406 or 456, such as power amplifier (PA), low-noise amplifier and RF filters, for the RF signal amplification and up/down-conversion. With the per-antenna signal brought to a reduced frequency (IF)/baseband (zero-IF), the signal of the entire subarray is interfaced to a shared array of signal conversion circuits 418, 450 via an analog multiplexor 416 that implements switches and combiners. The benefit of these configurations is two-fold. First, these configurations ensure that the required switching and bandwidth expansion happens at IF/Zero-IF frequencies, which reduces performance degradation. Second, the antenna grouping reduces the amount of bandwidth spreading required. For example, instead of 64 times spreading, the grouped architecture may only perform 4 times spreading.

Although FIG. 4B illustrates one example of a MIMO communication device MIMO communication device 400B, various changes may be made to FIG. 4B. For example, a different quantity of antenna elements, such as 2 or more, such as 3 or more, may be used in each of the plurality of subarrays.

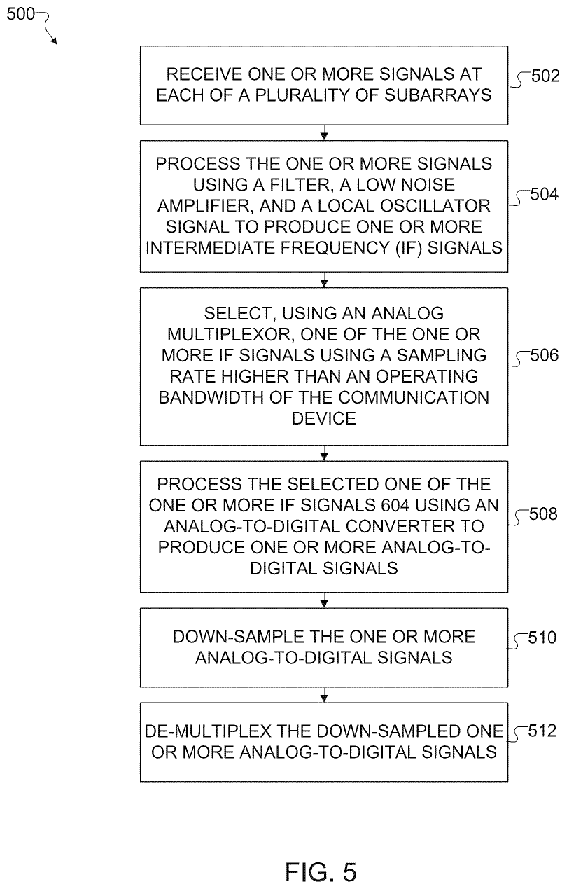

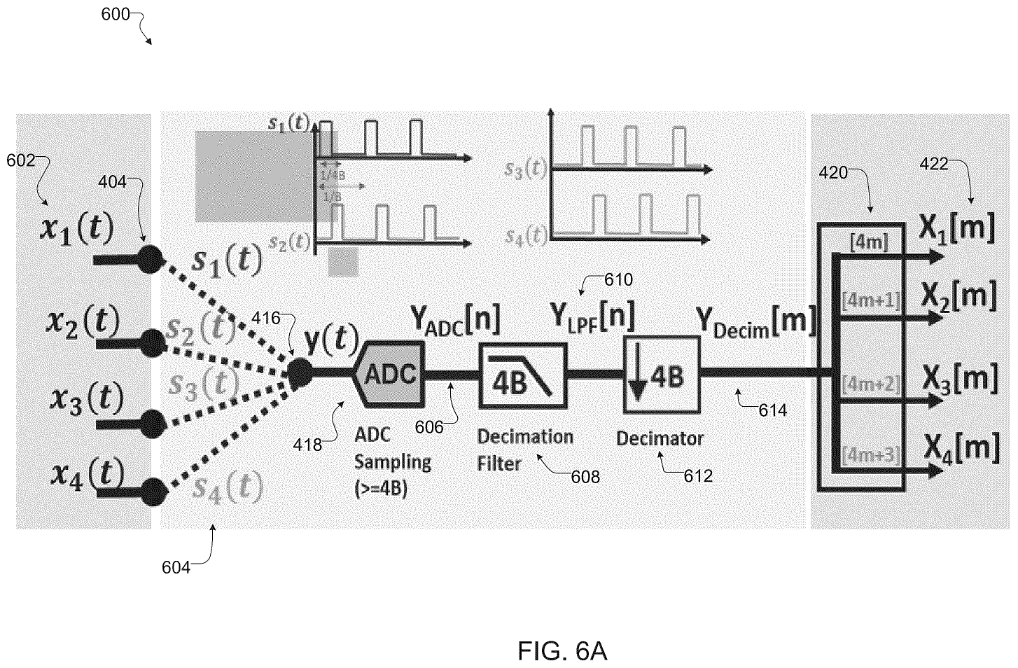

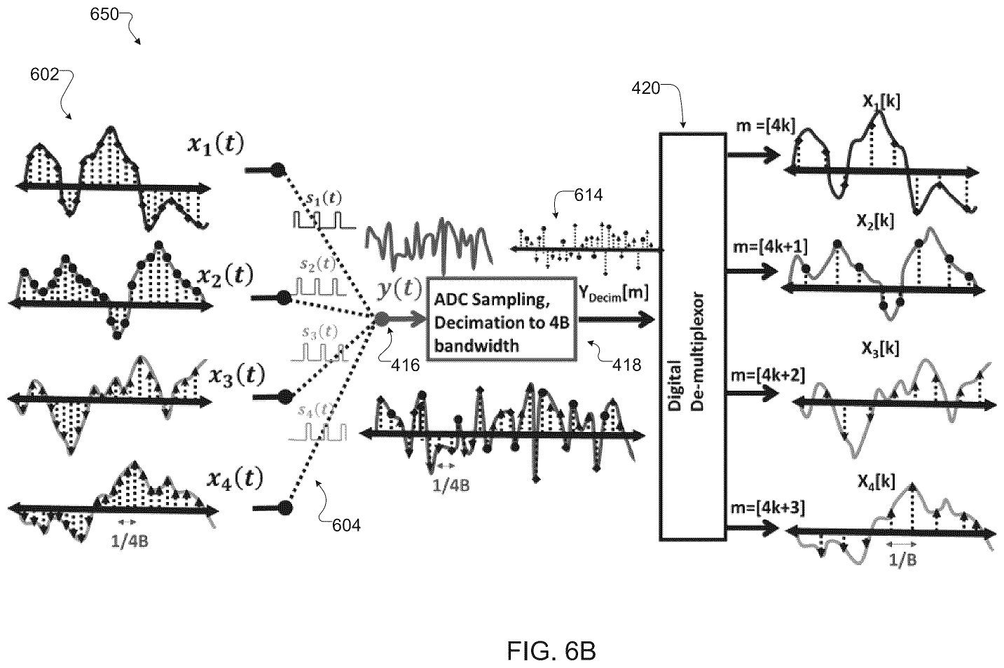

FIG. 5 illustrates an example method 500 of digital reconstruction according to embodiments of the present disclosure. An embodiment of the method illustrated in FIG. 5 is for illustration only. One or more of the components illustrated in FIG. 5 may be implemented in specialized circuitry configured to perform the noted functions or one or more of the components may be implemented by one or more processors executing instructions to perform the noted functions. FIG. 6A illustrates a schematic diagram of an example multiple input multiple output (MIMO) communication device 600 undergoing the example digital reconstruction method 500 of FIG. 5 according to embodiments of the present disclosure. FIG. 6B illustrates a schematic diagram 650 of example signals received by a multiple input multiple output (MIMO) communication device 600 undergoing the example digital reconstruction method 500 of FIG. 5 according to embodiments of the present disclosure. The MIMO communication device 600 is configured similarly to the MIMO communication device 400A of FIG. 4A unless otherwise described. The embodiments of the MIMO communication device 600 shown in FIGS. 6A and 6B are for illustration only. Other embodiments of the MIMO communication device 600 could be used without departing from the scope of this disclosure.

One or more signals are received at each of the plurality of subarrays in step 502. For example, each of the antenna elements of a plurality of subarrays of antenna elements 404 may receive one or more RF signals.

In step 504, processing the one or more signals 602 using a filter, a low noise amplifier, and a local oscillator signal to produce one or more intermediate frequency (IF) signals 604. For example, the one or more signals received by the plurality of subarrays of antenna elements 404 may be processed using the respective RF front end circuits 406 that include the RF filter 408, the LNA 410, and the down-converter mixer 412, producing one or more IF signals 604 that are passed to the multiplexor 416.

In step 506, the analog multiplexor, selects one of the one or more IF signals 604 using a sampling rate higher than an operating bandwidth of the communication device.

After LNA pre-amplification, down-conversion of the one or more signals 602 may be represented as xᵢ(t), iϵ{1,2,3,4}, with subscript i denoting the antenna index. The shared ADC interface has input as

$$y ( t ) = {\sum }_{i = 1}^{4} {x}_{i} ( t ) {s}_{i} ( t ) + n ( t )$$

where sᵢ(t) represents the on-off sequences implemented by the analog multiplexor 416, and n(t) represents the net white noise accumulated by the receiver. The on-off sequences may be mathematically written as,

$${s}_{i} ( t ) = \{ 1 if \begin{matrix}\frac{i - 1 + 4 K}{4 B} \leq t \leq \frac{i + 4 K}{4 B} \\ 0 otherwise\end{matrix} ∀ K ∈ {ℤ}^{+} , i = 1 , 2 , 3 , 4$$

The one or more IF signals 604 from different antenna elements in the subarray are selected in y(t) for different

$$\frac{1}{4 B}$$

time slots. Thus, for loss-less reconstruction, the ADC sampling rate Fₛ, should be higher than 4B, i.e. Fₛ≥4B. The sampled signal may be represented via a sample-and-hold equation as Y_{ADC}[n]=y(nTₛ), where

$${T}_{s} = \frac{1}{{F}_{s}} .$$

In step 508, processing the selected one of the one or more IF signals 604 using an analog-to-digital converter (ADC) to produce one or more analog-to-digital signals. For example, the sampled signal of the one or more IF signals 604 is passed to a signal conversion circuit, e.g., an ADC, of the array of signal conversion circuits 418 to convert the one or more IF signals 604 from analog signals to digital signals for further processing.

The one or more analog-to-digital signals 606 are down-sampled in step 510. Even if the ADC samples at a higher rate compared to Fₛ, only a total 4B bandwidth may be necessary. As such, the one or more analog-to-digital signals 606 (Y_{ADC}[n]) are passed through a low-pass filter 608 with stop-band around 4B producing low pass filtered signals 610 (Y_{LPF}[n]), and then the down-sampled to 4B bandwidth using a decimator 612 to produce decimator signals 614 (Y_{DECIM}[m]). Mathematically, this is represented as:

$${Y}_{LPF} [ n ] = L ( {Y}_{ADC} [ n ] )$$

$$and then$$

$${Y}_{DECIM} [ m ] = {Y}_{LPF} [ m * \frac{Fs}{4 B} ] .$$

For example, if Fₛ=8B, then Y_{DECIM}[m]=Y_{LPF}(2m), which down-samples the low-pass filtered signal 610 by discarding half the samples. Decimation is not limited by the example herein and may be accomplished using variations conditioned on Fₛ. If Fₛ is not an integer multiple, a fractional down-sampling process may be done by using a sync filter.

Due of the sampling and decimation process, the decimator signals 614 represent the quantized value for the analog samples y(t), at times [m−1/4B, m/4B]. Thus,

$${Y}_{DECIM} [ m ] = Q ( y ( t ) , \frac{m - 1}{4 B} , \frac{m}{4 B} ) .$$

Since at times [4k-1/4B, 4k/4B], only s₁(t)=1, and other sⱼ(t), j≠k are 0.

$${Y}_{DEC IM} [ 4 k ] = Q ( {x}_{1} ( t ) + n ( t ) , \frac{4 k - 1}{4 B} , \frac{4 k}{4 B} )$$

That is,

$${Y}_{DECIM} [ 4 k ] = Q ( {x}_{1} ( t ) + n ( t ) , \frac{k}{B} - \frac{1}{4 B} , \frac{k}{B} )$$

Which shows that both xₖ(t)+n(t) are sampled with total

$$\frac{1}{4 B}$$

time

In a traditional, separate ADC system, however,

$${\hat{Y}}_{DECIM} [ k ] = Q ( {x}_{1} ( t ) + n ( t ) , 0 , \frac{k}{B} )$$

With xₖ(t)+n(t) sampled with total

$$\frac{1}{B}$$

time,

By using LNA pre-amplification, a full-scale input, and operating the ADC in similar spurious-free dynamic ranges (SFDRs) across the 4 times faster rate, the faster ADC maintains similar signal-to-noise ratios (SNRs) compared to using slower, separate ADCs.

$${Y}_{DECIM} [ 4 k ] \approx {\hat{Y}}_{DECIM} [ k ] \approx {X}_{1} [ k ] + n [ k ]$$

For example, if a slower

$$\frac{1}{B}$$

time-sampling ADC and a faster

$$\frac{1}{4 B}$$

time-sampling ADC have similar SFDR, then the Y_{DECIM}[4k] will have similar output SNR as Ý_{DECIM}[k] to reconstruct

$${X}_{1} [ k ] .$$

Similar analysis may be done to show that Y_{DECIM}[4k+1] reconstructs X₂[k], Y_{DECIM}[4k+2] reconstructs X₃[k], and Y_{DECIM}[4k+3] reconstructs X₄[k] as shown in FIG. 6B.

The down-sampled one or more analog-to-digital signals 606 are de-multiplexed in step 512. For example, the decimator signals 614 of the one or more digital signals 606 are de-multiplexed using the de-multiplexer 420 into individual signals corresponding to each of the antenna elements of the subarray for processing in the MIMO processing module 422.

The method 500 provides an advantage over other MIMO receiving methods in that the individual analog domain antenna signals get reconstructed with minimal SNR loss from the single combined group signal, which is sampled at M times the signal bandwidth via the shared ADC.

Although FIG. 5 illustrates one example digital reconstruction method 500, various changes may be made to FIG. 5. For example, while shown as a series of steps, various steps in FIG. 5 could overlap, occur in parallel, occur in a different order, or occur any number of times. For example, the MIMO communication device 400A may continuously repeat steps 504 through 506.

Similarly, although FIGS. 6A and 6B illustrate one example of a MIMO communication device, various changes may be made to FIGS. 6A and 6B. For example, a different quantity of antenna elements, such as 2 or more, such as 3 or more, may be used in each of the plurality of subarrays.

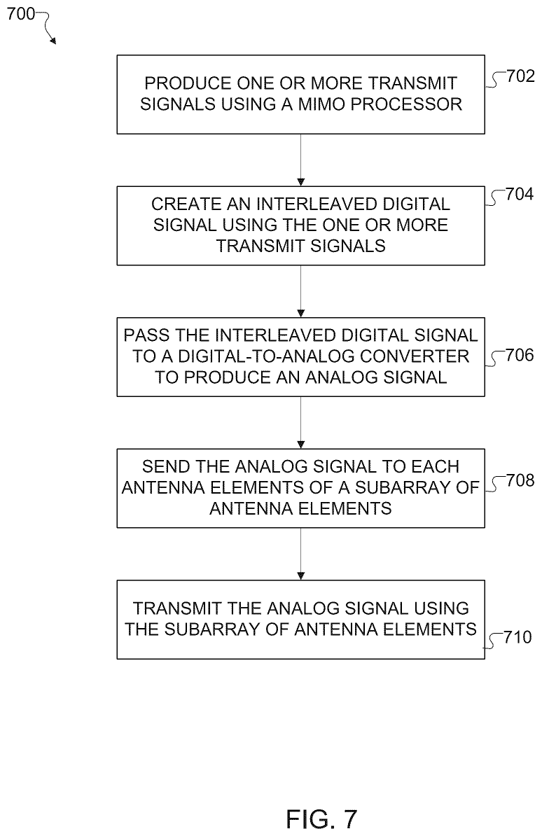

To perform MIMO transmitting functions, a MIMO communication device configured for transmission may perform an analog synthesis method that is similar, though reciprocal, to the digital reconstruction method 500, as shown in FIG. 7, for example.

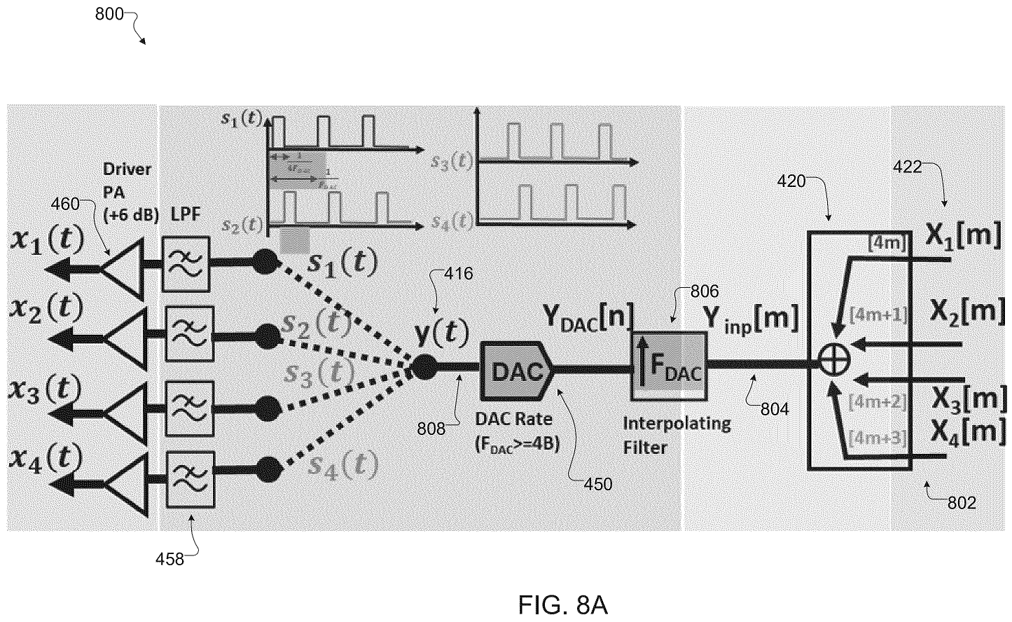

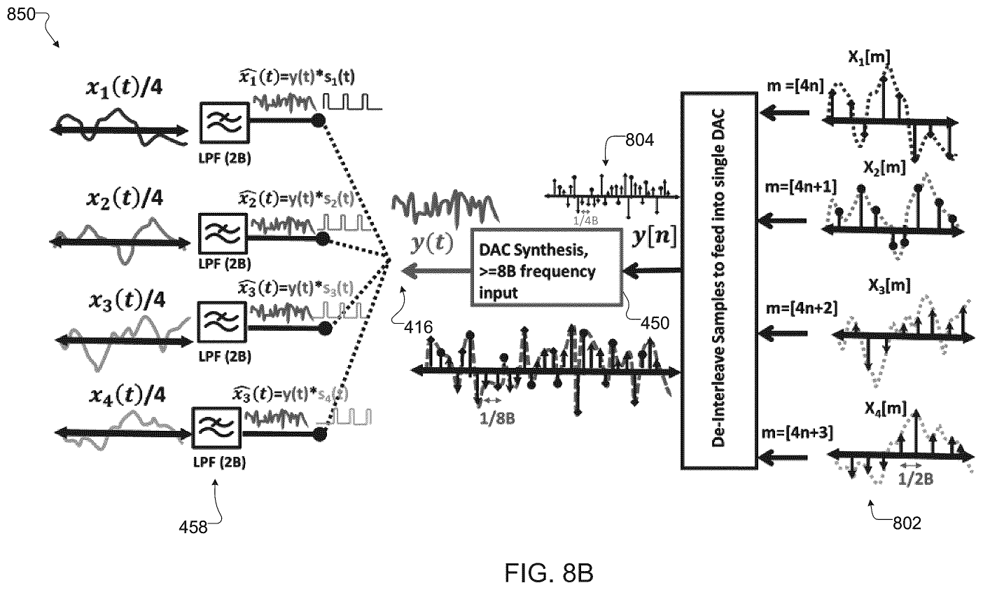

FIG. 7 illustrates an example method 700 of analog synthesis according to embodiments of the present disclosure. An embodiment of the method illustrated in FIG. 7 is for illustration only. One or more of the components illustrated in FIG. 7 may be implemented in specialized circuitry configured to perform the noted functions or one or more of the components may be implemented by one or more processors executing instructions to perform the noted functions. FIG. 8A illustrates a schematic diagram of an example multiple input multiple output (MIMO) communication device 800 undergoing the example analog synthesis method 700 of FIG. 7 according to embodiments of the present disclosure. FIG. 8B illustrates a schematic diagram 850 of example signals transmitted by a multiple input multiple output (MIMO) communication device undergoing the example analog synthesis method 700 of FIG. 7 according to embodiments of the present disclosure. The MIMO communication device 800 is configured similarly to the MIMO communication device 400B of FIG. 4B unless otherwise described. The embodiment of the MIMO communication device 800 shown in FIGS. 8A and 8B are for illustration only. Other embodiments of the MIMO communication device 800 could be used without departing from the scope of this disclosure.

One or more transmit signals 802 are produced using a MIMO processor in step 702.

The one or more transmit signals 802 are used to create an interleaved digital signal 804 in step 704. These individual antenna signals may be synthesized while using a single over-clocked DAC interface. The purpose of doing so is to generate the B bandwidth analog signals for each antenna, xᵢ(t), iϵ{1,2,3,4}, from the digital baseband samples Xᵢ[m] while using a single 4B bandwidth DAC.

The interleaved digital signal is created out of Xᵢ[m], m={0, 1, . . . , N−1}

$${Y}_{inp} [ n ] = \{ \begin{matrix}{X}_{1} [ m ] ∀ n = 4 m \\ {X}_{2} [ m ] ∀ n = 4 m + 1 \\ {X}_{3} [ m ] ∀ n = 4 m + 2 \\ {X}_{4} [ m ] ∀ n = 4 m + 3\end{matrix}$$

Similar to the ADC reconstruction steps of method 500, to synthesize the 4B bandwidth signals accurately with no cross-talks, the DAC frequency may need to be at least 4B, that is, F_{DAC}≥4B. As such, the input to the DAC will be an interpolated signal that takes the input 4B signal and matches it to F_{DAC}, resulting in Y_{DAC}[n]=I(Yᵢₙₚ[n]), where I(.) is any standard interpolating function.

In step 706, the interleaved digital signal 804 is passed to a digital-to-analog converter (DAC), e.g., a signal conversion circuit of the array of signal conversion circuits 450, having a sampling rate higher than an operating frequency of the MIMO communication device 800 to produce an analog signal 808. Optionally, the interleaved digital signal 804 is passed through or filtered using an interpolating filter 806 before passing the interleaved digital signal 804 to the DAC. The DAC will synthesize the interpolated and interleaved signal Y_{DAC}[n], and approximate it to y(t), with an analog representation assuming a step approximating DAC, with t_{DAC}=1/F_{DAC}.

$$y ( t ) = {Y}_{DAC} [ n ] , n {t}_{DAC} \leq t < ( n + 1 ) {t}_{DAC}$$

In step 708, the analog signal 808 is sent to each of the antenna elements of the respective subarray of antenna elements using the multiplexor 416 coupled to the subarray of antenna elements. The analog multiplexor 416 will clock the input signal y(t), to create yᵢ(t)=y(t)sᵢ(t), with the RF front end circuits 456 of the i-th antenna getting y(t)sᵢ(t) instead of y(t).

As such, sᵢ(t) should be configured such that yᵢ(t) contains only the synthesized signal from the xᵢ samples. As the DAC should operate at a higher sampling rate than bandwidth, even when used without bandwidth spreading (to reduce out of band leakage), the DAC frequency may be higher than the 4B bandwidth. To create harmonics far-enough to get filtered by the RF filters, the analog multiplexor 416 may need to switch at a faster-rate for transmission. For example, the analog multiplexor 416 may switch at F_{DAC}, instead of 4B, where, for example, F_{DAC}≈8B. As such, for the transmitter, the choice of switching codes sᵢ(t) is given by:

$${s}_{i} ( t ) = \{ \begin{matrix}1 & if \frac{i - 1 + 4 K}{{F}_{DAC}} \leq t \leq \frac{i + 4 K}{{F}_{DAC}} ∀ K ∈ {ℤ}^{+} , i = 1 , 2 , 3 , 4 \\ 0 & otherwise\end{matrix}$$

This creates a 1/4 duty-cycle on-off square wave, with frequency

$$\frac{{F}_{DAC}}{4} .$$

The signal at the i-th arm of the multiplexor is as follows:

$${y}_{i} ( t ) = {s}_{i} ( t ) y ( t )$$

As described above, the sᵢ(t) will load y(t) onto the i-th transmitter RF front end circuits 456, for times

$$\frac{i - 1 + 4 K}{{F}_{DAC}} \leq t \leq \frac{i + 4 K}{{F}_{DAC}} ∀ K ∈ {ℤ}^{+} ,$$

otherwise the signal will be 0. Thus, s₁(t) (i=1) will select the interpolated samples corresponding to X₁[K=m] for 25% on time of the 1/4 duty cycle square wave and be 0 for the remaining 75% off-time. This will effectively multiply the analog signal (x₁(t)) corresponding to interpolated and synthesized X₁[K=m], with the 1/4 duty cycle square wave resulting in harmonics at the frequency of the square wave (F_DAC/4). If F_{DAC}=8B, then the harmonics will get created at 2B, which may be low pass filtered, using a low pass filter 458, to keep only the DC component of the signal, corresponding to

$$\frac{{x}_{1} ( t )}{4} ,$$

because the 1/4 duty cycle on-off square wave will multiply the voltage signal by 1/4 (the DC component of Fourier series). This results in a 1/16 power loss, equivalent to about a 12 dB power loss. To ensure the same power amplifier output level and effective isotropic radiated power, the 12 dB loss may need to be compensated by a first power amplifier 460, e.g., a driver power amplifier, before a second power amplifier 464, e.g., the main power amplifier. More generally, if there are M antennas in the group, there will be 20*log 10 (M) power loss, since a 1/M duty cycle code is implemented, and the first power amplifier 460 may need to compensate this reduction.

An important consideration is the compensation of the 12 dB loss by the first power amplifier 460, and the fact that this leads to minimal power consumption overhead. The reason is that the extra power consumption due to the required 12 dB compensation is minimal compared to the power consumption of the second power amplifier 464. That is, the output power level of the first power amplifier 460 is about 20 dB to about 30 dB lower than the output power level of the second power amplifier 464. In other words, the power consumption of the first power amplifier 460 is about 0.1% to about 0.2% that of the second power amplifier 464. Thus, the 12 dB extra requirement may be met with about 0.1% to about 0.2% power overhead, while keeping the required power savings from the reduction in number of DACs intact.

After filtering and amplification, the analog signal is transmitted using the subarray of antenna elements in step 710.

In both the digital reconstruction method 500 and the analog synthesis method 700, there may be an optional crosstalk calibration component. The reconstruction/synthesis can get affected by non-ideal decimation/interpolation filters in the receive/transmit signal path. This can lead to cross-talks. As an example, components of X₂[m], X₃[m] and X₄[m], as shown in FIG. 8B, can crop into the receive/transmit path of X₁[m] as a consequence of sharing the same receive/transmit signal path. In one variation of this embodiment, this may be resolved via a one-time calibration process of measuring the crosstalk and pre/post coding to cancel the crosstalk. In other variations, this calibration may be absorbed within the channel estimation process and may be more simply be resolved by standard MIMO pre/post coding itself.

Although FIG. 7 illustrates one example analog synthesis method 700, various changes may be made to FIG. 7. For example, while shown as a series of steps, various steps in FIG. 7 could overlap, occur in parallel, occur in a different order, or occur any number of times. For example, the MIMO communication device 800 may continuously repeat steps 704 through 706.

Similarly, although FIGS. 8A and 8B illustrate one example of a MIMO communication device 800, various changes may be made to FIGS. 8A and 8B. For example, a different quantity of antenna elements, such as 2 or more, such as 3 or more, may be used in each of the plurality of subarrays.

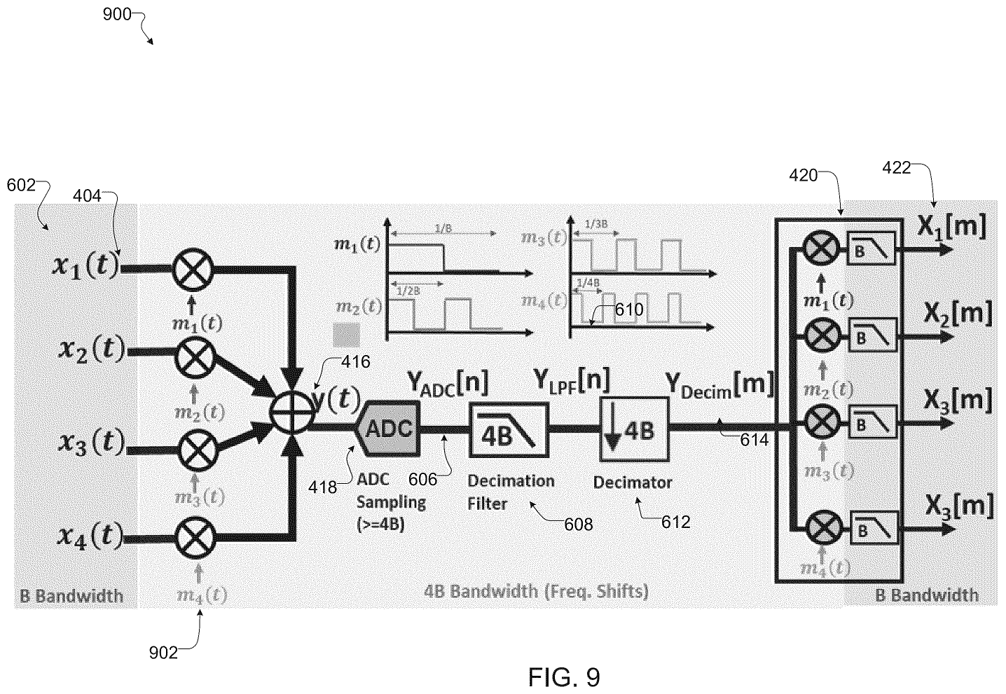

FIG. 9 illustrates a schematic diagram of an example multiple input multiple output (MIMO) communication device 900 according to embodiments of the present disclosure. The embodiment of the MIMO communication device 900 shown in FIG. 9 is for illustration only. Other embodiments of the MIMO communication device 900 could be used without departing from the scope of this disclosure. The MIMO communication device 900 is configured similarly to the MIMO communication device 400A of FIG. 4A except as otherwise described.

As shown in FIG. 9, the MIMO communication device 900 includes a plurality of frequency mixers 902. As such, the M=4 antenna groups are multiplexes in frequency domain instead of time domain. The mixed signals can then be reconstructed by re-mixing with the same frequency tones and low pass filtering. The MIMO communication device 900 is configured to receive signals but may be configured to transmit as shown above. Instead of time-domain separated clocks, the plurality of frequency mixers 902 have different frequency inputs (m_i(t)) that lead to antenna multiplexing in frequency domain.

Although FIG. 9 illustrates one example of a MIMO communication device 900, various changes may be made to FIG. 9. For example, a different quantity of antenna elements, such as 2 or more, such as 3 or more, may be used in each of the plurality of subarrays.

The present disclosure provides for systems and methods for MIMO systems that incorporate an array of ADCs or an array of DACs, each of the ADCs or DACs coupled to a subarray of antenna elements of a plurality of subarray and an analog multiplexer. This configuration allows interfacing with a large number of antennas using a reduced number of ADC/DACs, leading to a smaller power and economic footprint while maintaining the high throughput performance of a traditional DBF architecture.

The above flowcharts illustrate example methods that may be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A multiple input multiple output (MIMO) communication device, comprising:
an array of antenna elements comprising a plurality of subarrays of the antenna elements;
radio frequency (RF) front end circuits coupled to the antenna elements, respectively; and
an array of signal conversion circuits coupled to the array of the antenna elements, the signal conversion circuits coupled to the plurality of subarrays, respectively, such that each of the plurality of subarrays is coupled to one of the signal conversion circuits.

2. The MIMO communication device of claim 1, wherein:
the array of antenna elements is configured to receive RF signals, and
the array of signal conversion circuits is an array of analog-to-digital converters.

3. The MIMO communication device of claim 1, wherein:
the array of antenna elements is configured to transmit RF signals, and
the array of signal conversion circuits is an array of digital-to-analog converters.

4. The MIMO communication device of claim 1, wherein the array of signal conversion circuits is coupled to a de-multiplexor.

5. The MIMO communication device of claim 1, wherein each of the plurality of subarrays is coupled to a multiplexor such that each of plurality of subarrays interfaces with the respective signal conversion circuit through the multiplexor.

6. The MIMO communication device of claim 5, wherein the multiplexor is configured to switch between each of the antenna elements of a subarray of the plurality of subarrays in synchronization with a sampling bandwidth of the respective signal conversion circuit.

7. The MIMO communication device of claim 5, wherein the multiplexor is a frequency domain multiplexor.

8. A communication method, comprising:
processing one or more signals using a multiple input multiple output (MIMO) communication device, the MIMO communication device comprising:
an array of antenna elements comprising a plurality of subarrays of the antenna elements;
radio frequency (RF) front end circuits coupled to the antenna elements, respectively; and
an array of signal conversion circuits coupled to the array of the antenna elements, the signal conversion circuits coupled to the plurality of subarrays, respectively, such that each of the plurality of subarrays is coupled to one of the signal conversion circuits.

9. The communication method of claim 8, further comprising:
combining the one or more signals received at each of the plurality of subarrays into a single analog signal using the array of signal conversion circuits,
wherein processing the one or more signals using the MIMO communication device comprises receiving one or more signals using the array of antenna elements.

10. The communication method of claim 9, wherein combining the one or more signals received at each of the plurality of subarrays into a single analog signal using the array of signal conversion circuits comprises:
processing the one or more signals using a filter, a low noise amplifier, and a local oscillator signal to produce one or more intermediate frequency (IF) signals;
selecting, using an analog multiplexor, one of the one or more IF signals using a sampling rate higher than an operating bandwidth of the communication device; and
processing the selected one of the one or more IF signals using an analog-to-digital converter to produce one or more analog-to-digital signals.

11. The communication method of claim 10, further comprising:
down-sampling the one or more analog-to-digital signals; and
de-multiplexing the down-sampled one or more analog-to-digital signals.

12. The communication method of claim 8, further comprising:
producing one or more transmit signals using a MIMO processor;
transmitting the one or more transmit signals to each of the array of signal conversion circuits,
wherein processing the one or more signals using the MIMO communication device comprises transmitting the one or more signals using the array of antenna elements.

13. The communication method of claim 12, wherein transmitting the one or more transmit signals to the array of signal conversion circuits comprises:
creating an interleaved digital signal using the one or more transmit signals;
passing the interleaved digital signal to a digital-to-analog converter having a sampling rate higher than an operating frequency of the MIMO communication device to produce an analog signal;
sending the analog signal to each of the antenna elements of the respective subarray of antenna elements using an analog multiplexor coupled to the subarray of antenna elements; and
transmitting the analog signal using the subarray of antenna elements.

14. The communication method of claim 13, wherein passing the interleaved digital signal to a digital-to-analog converter comprises filtering the interleaved digital signal using an interpolating filter before passing the interleaved digital signal to the digital-to-analog converter.

15. A non-transitory computer-readable medium comprising program code, that when executed by at least one processor of an electronic device, causes the electronic device to:
process one or more signals using an array of antenna elements comprising a plurality of subarrays of the antenna elements, radio frequency (RF) front end circuits coupled to the antenna elements, respectively, and an array of signal conversion circuits coupled to the array of the antenna elements, the signal conversion circuits coupled to the plurality of subarrays, respectively, such that each of the plurality of subarrays is coupled to one of the signal conversion circuits.

16. The non-transitory computer-readable medium of claim 15, wherein the program code, that when executed by the at least one processor, causes the electronic device to process one or more signals comprises program code, that when executed by the at least one processor, causes the electronic device to receive one or more signals using the array of antenna elements, and further comprising program code, that when executed by the at least one processor of an electronic device, causes the electronic device to:
combine the one or more signals received at each of the plurality of subarrays into a single analog signal using the array of signal conversion circuits.

17. The non-transitory computer-readable medium of claim 16, wherein the program code, that when executed by the at least one processor, causes the electronic device to combine the one or more signals received at each of the plurality of subarrays into a single analog signal using the array of signal conversion circuits, further comprises program code, that when executed by the at least one processor, causes the electronic device to:
process the one or more signals using a filter, a low noise amplifier, and a local oscillator signal to produce one or more intermediate frequency (IF) signals;
select, using an analog multiplexor, one of the one or more IF signals using a sampling rate higher than an operating bandwidth; and
process the selected one of the one or more IF signals using an analog-to-digital converter to produce one or more analog-to-digital signals.

18. The non-transitory computer-readable medium of claim 17, further comprising program code, that when executed by the at least one processor, causes the electronic device to:
down-sample the one or more analog-to-digital signals; and
de-multiplex the down-sampled one or more analog-to-digital signals.

19. The non-transitory computer-readable medium of claim 18, wherein the program code, that when executed by the at least one processor, causes the electronic device to process one or more signals comprises program code, that when executed by the at least one processor, causes the electronic device to transmit one or more signals using the array of antenna elements, and further comprising program code, that when executed by the at least one processor of an electronic device, causes the electronic device to:
produce one or more transmit signals using a MIMO processor; and
transmit the one or more transmit signals to each of the array of signal conversion circuits.

20. The non-transitory computer-readable medium of claim 19, wherein the program code, that when executed by the at least one processor, causes the electronic device to transmit the one or more transmit signals to the array of signal conversion circuits, comprises program code, that when executed by the at least one processor, causes the electronic device to:
create an interleaved digital signal using the one or more transmit signals;
pass the interleaved digital signal to a digital-to-analog converter having a sampling rate higher than an operating frequency of the electronic device to produce an analog signal;
send the analog signal to each of the antenna elements of the respective subarray of antenna elements using an analog multiplexor coupled to the subarray of antenna elements; and
transmit the analog signal using the subarray of antenna elements.
